(19) United States
(12) Patent Application Publication
(10) Pub. No.: US 2012/0321426 A1
(43) Pub. Date: Dec. 20, 2012

(54) TRANSFER ROBOT

(75) Inventors: Kentaro TANAKA, Kitakyushu-shi (JP); Kouji Tsukuda, Kitakyushu-shi (JP); Satoshi Sueyoshi, Kitakyushu-shi (JP)

(73) Assignee: KABUSHIKI KAISHA YASKAWA DENKI, Kitakyushu-shi (JP)

(21) Appl. No.: 13/418,346

(22) Filed: Mar. 13, 2012

(30) Foreign Application Priority Data
Jun. 17, 2011 (JP) 2011-134743

(51) Int. Cl. B25J 18/00; B25J 5/02; B25J 17/00

(52) U.S. Cl. 414/728; 414/680

(57) ABSTRACT

A transfer robot includes a swivel base, a strut, first and second elevation arms, and a horizontal arm unit. The swivel base includes a base part to swivel about a vertical axis thereof and a extension part extending from the base part in one horizontal direction. The strut is vertically extended from a leading end of the extension part. The first and second elevation arms are provided to rotate about a horizontal axis. The horizontal arm unit is supported on the leading end portion of the second elevation arm to rotate about a horizontal axis.

### CROSS-REFERENCE TO RELATED APPLICATIONS

The present application claims priority under 35 U.S.C. §119 to Japanese Patent Application No. 2011-134743 filed Jun. 17, 2011. The contents of the application are incorporated herein by reference in its entirety.

### BACKGROUND OF THE INVENTION

1. Field of the Invention

The present invention relates to a transfer robot.

2. Description of the Related Art

Transfer robots, which transfer a thin plate workpiece such as a glass substrate for a liquid crystal display or a semiconductor wafer from and into a stocker, are conventionally known.

As an example of such a transfer robot, a robot is known in which a pair of leg units are operated to move in a vertical direction and a horizontal arm unit disposed on an upper portion thereof transfers an object to be transferred such as the thin plate workpiece (for example, see Japanese Patent No. 4466785).

### SUMMARY OF THE INVENTION

In accordance with an aspect of the present invention, there is provided a transfer robot including: a swivel base including a base part attached to a base so as to swivel about a vertical axis thereof and a extension part extending from the base part in one horizontal direction; a strut vertically extended from a leading end portion of the extension part; a first elevation arm supported on a leading end portion of the strut via a first articulated part and configured to rotate about a first horizontal axis; a second elevation arm supported on a leading end of the first elevation arm via a second articulated part and configured to rotate about a second horizontal axis which is parallel to the first horizontal axis; and a horizontal arm unit including an arm part for moving a hand part in a direction parallel to the first and second horizontal axis, on which an object to be transferred is mounted, the horizontal arm unit being supported on a leading end portion of the second elevation arm via a third articulated part and being configured to rotate about a third horizontal axis which is parallel to the second horizontal axis, wherein a portion of the arm part in the horizontal arm unit can be operated at a position lower than an upper surface of the extension part.

### BRIEF DESCRIPTION OF THE DRAWINGS

The objects and features of the present invention will become apparent from the following description of embodiments, given in conjunction with the accompanying drawings, in which:

FIG. 1 is a schematic view illustrating a transfer robot in accordance with a first embodiment of the present invention;

FIG. 2 is a view illustrating a positional relationship between a swivel base and a horizontal arm unit;

FIG. 3A is a front view schematically illustrating the transfer robot in which the horizontal arm unit is disposed at an uppermost position thereof;

FIG. 3B is a side view schematically illustrating the transfer robot in which the horizontal arm unit is disposed at an uppermost position thereof;

FIG. 3C is a side sectional view schematically illustrating a portion of the interior configuration of the transfer robot;

FIG. 4A is a front view schematically illustrating the transfer robot in which the horizontal arm unit is disposed at a lowermost position thereof;

FIG. 4B is a side view schematically illustrating the transfer robot in which the horizontal arm unit is disposed at a lowermost position thereof;

FIG. 5A is a schematic view illustrating a transfer robot in accordance with a second embodiment of the present invention;

FIG. 5B is a schematic view illustrating the transfer robot in accordance with the second embodiment; and

FIG. 6 is a schematic view illustrating a transfer robot in accordance with a third embodiment of the present invention.

### DESCRIPTION OF THE EMBODIMENTS

Hereinafter, transfer robots in accordance with embodiments of the present invention will be described in detail with reference to the accompanying drawings. However, it is noted that the present invention is not limited to the embodiments depicted below.

### First Embodiment

### Configuration of Transfer Robot

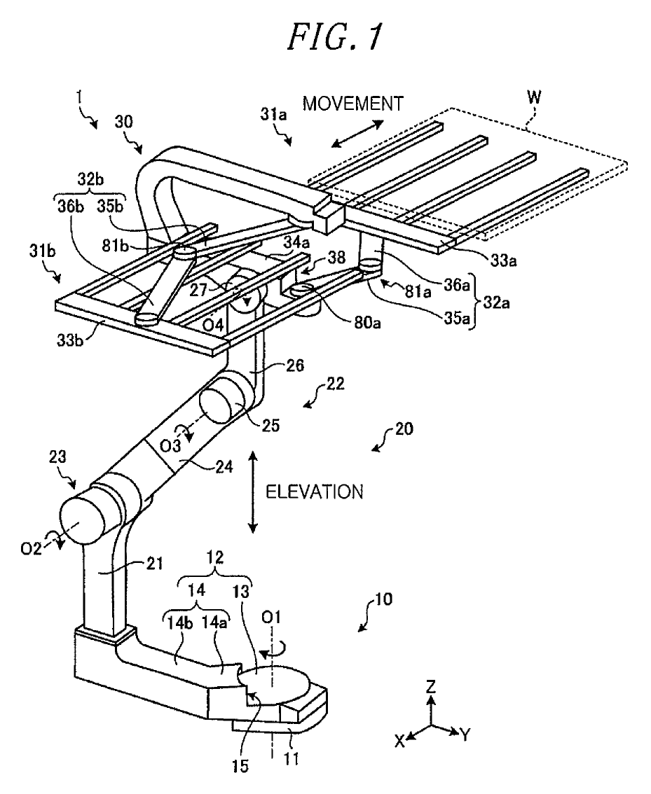

First, the configuration of the transfer robot in accordance with a first embodiment of the present invention will be described by referring to FIG. 1. FIG. 1 is a view schematically illustrating the transfer robot in accordance with the first embodiment. Hereinafter, for convenience of explanation, positional relationships between each of the components of the transfer robot 1 will be described by referring to the state of the transfer robot 1 as illustrated in FIG. 1 as the swivel position. Herein, a vertical direction is referred to as the Z-axis.

As shown in FIG. 1, the transfer robot 1 in accordance with the first embodiment includes a swivel mechanism 10, an elevation mechanism 20 and a horizontal arm unit 30.

The swivel mechanism 10 includes a base 11 and a swivel base 12. The swivel base 12 swivels relative to the base 11 about a swivel axis O1 which is a vertical axis.

As the swivel base 12 swivels, the elevation mechanism 20 and the horizontal arm unit 30 swivel about the swivel axis O1.

The swivel base 12 includes an approximately disk-shaped base part 13 swivelably attached to the base 11 and a extension part 14 extending horizontally from one end of the base part 13. The extension part 14 includes a first member 14a extending from one end of the base part 13 in the positive direction of the X axis while being inclined in the negative direction of the Y axis and a second member 14b extending from a leading end of the first member 14a in the negative direction of the Y axis. Accordingly, the extension part 14 is formed in an approximate L shape when seen in a plan view. Further, an upper surface of the base part 13 is formed at a position lower than an upper surface of the extension part 14 and thus a stepped portion 15 is formed between the base part 13 and the extension part 14.

The elevation mechanism 20 includes a strut 21 vertically extending from a leading end of the extension part 14 and a leg unit 22 which has a base end supported on the leading end of the strut 21 and supports the horizontal arm unit 30 on a leading end thereof. This elevation mechanism 20 raises and lowers the horizontal arm unit 30 in a vertical direction along an axis parallel to the swivel axis O1 by changing the posture of the leg unit 22.

The leg unit 22 includes a first elevation arm 24 and a second elevation arm 26. The first elevation arm 24 has a base end which is connected to the negative side of the X axis in the leading end of the strut 21 via a first articulated part 23. By doing so, the first elevation arm 24 is supported on the leading end of the strut 21 so as to swivel about a horizontal articulated axis O2 of the first articulated part 23.

The second elevation arm 26 has a base end which is connected to the negative side of the X axis in the leading end of the first elevation arm 24 via a second articulated part 25. By doing so, the second elevation arm 26 is supported on the leading end of the first elevation arm 24 so as to swivel about a horizontal articulated axis O3 of the second articulated part 25 parallel to the articulated axis O2.

The horizontal arm unit 30 is connected to the negative side of the X axis in the leading end of the second elevation arm 26 via a third articulated part 27. By doing so, the horizontal arm unit 30 is supported on the leading end of the second elevation arm 26 so as to swivel about a horizontal articulated axis O4 of the third articulated part 27 parallel to the articulated axis O3.

As such, in the transfer robot 1 in accordance with the first embodiment, the horizontal arm unit 30 is supported by one leg unit 22. Accordingly, the transfer robot can have a simple configuration, as compared to a conventional transfer robot in which the horizontal arm unit 30 is supported by two or more elevation arm units. Herein, the articulated axis O2 corresponds to a first horizontal axis, the articulated axis O3 corresponds to a second horizontal axis, and the articulated axis O4 corresponds to a third horizontal axis.

The horizontal arm unit 30 includes a lower side arm unit 31a and an upper side arm unit 31b. The lower side arm unit 31a includes a hand part 33a on which a thin plate workpiece W as an object to be transferred is mounted, an arm part 32a for supporting the hand part 33a on a leading end thereof and a lower side support member 34a. In this horizontal arm unit 30, by expansion and contraction of the arm part 32a, the hand part 33a having the workpiece W moves in a direction parallel to the articulated axis O3 on the swivel axis O1 side relative to the strut 21.

The arm part 32a includes a base end side arm 35a and a leading end side arm 36a. The lower side support member 34a is supported on the leading end of the second elevation arm 26 so as to swivel about the articulated axis O4 of the third articulated part 27. A base end of the base end side arm 35a is supported on the lower side support member 34a.

A base end of the leading end side arm 36a is rotatably supported on the leading end of the base end side arm 35a. The hand part 33a is rotatably supported on the leading end of the leading end side arm 36a. Further, as the base end side arm 35a and the leading end side arm 36a rotate, the hand part 33a moves linearly in the X axis direction. In a case where the transfer robot 1 is in a swivel position as shown in FIG. 1, the moving direction of the hand part 33a and the extending direction of the arm part 32a is referred to as the X axis direction.

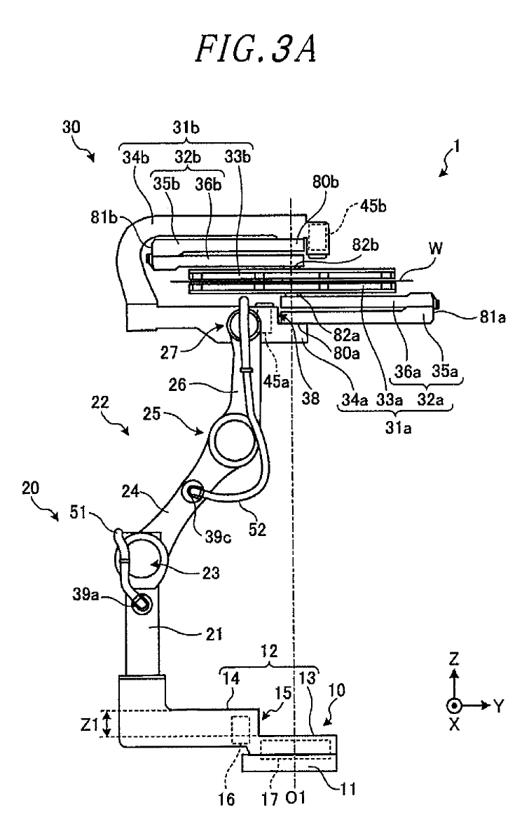

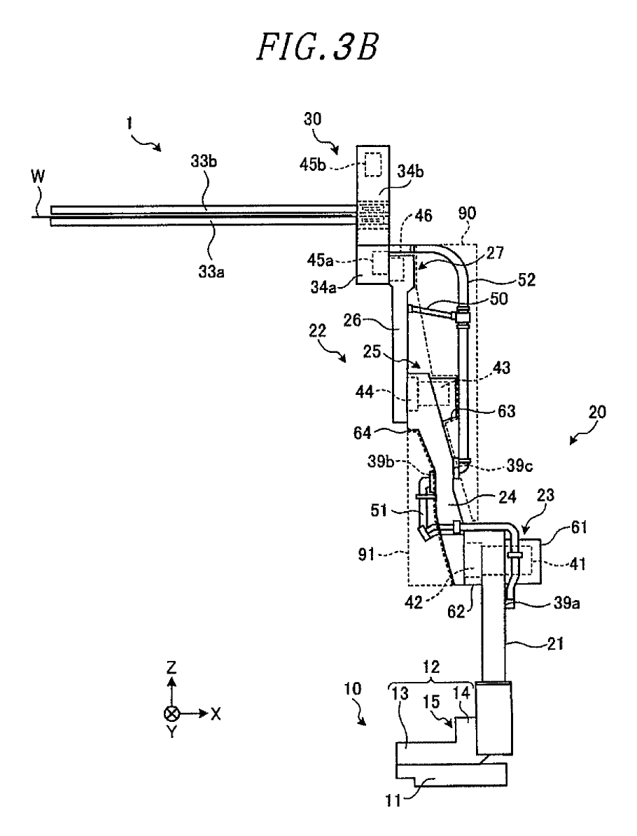

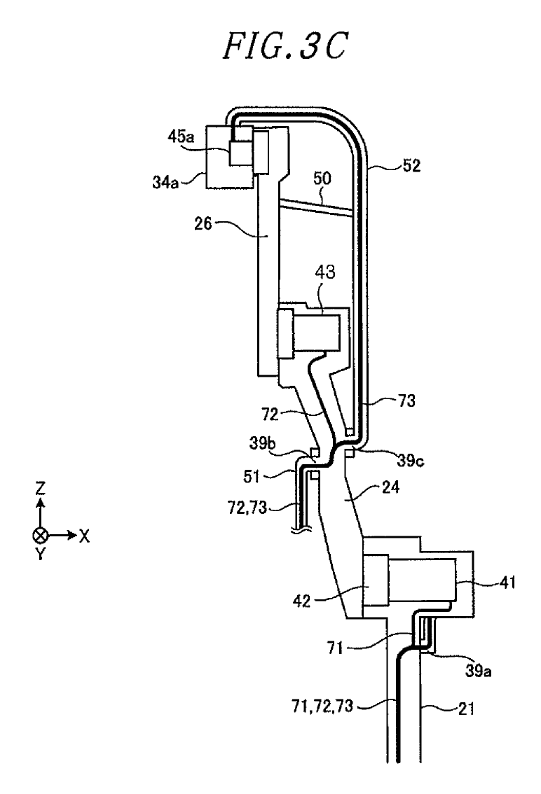

As is apparent from FIG. 3A that will be described in detail below, an elbow articulated part 81a connecting the base end side arm 35a and the leading end side arm 36a of the arm part 32a is configured to be operated at the opposite side of the extension part 14 of the swivel base 12 with respect to the swivel axis O1 that is a swivel center of the swivel base 12. That is, a folding direction of the arm part 32a is opposite to a direction of the extension part 14 with respect to the swivel center of the swivel base 12.

In addition, as can be seen from the X axis direction shown in FIG. 3A, a base end articulated part 80a of the base end side arm 35a is supported by the lower side support member 34a above the base part 13. Accordingly, as can be seen in the X axis direction shown in FIG. 3A, the third articulated part 27 supports the lower side support member 34a at a position offset from the swivel axis O1 towards the negative side of Y axis.

Further, in the transfer robot 1 of the present embodiment, as shown in FIG. 1, a stepped portion 38 is formed on an upper surface of the leading end portion of the lower side support member 34a so that the height of the leading end side is lowered. The base end side arm 35a is rotatably supported on an upper surface of the lower stage of the stepped portion 38. Meanwhile, as mentioned above, an upper surface of the base part 13 is formed at a position lower than the upper surface of the extension part 14 and thus a stepped portion 15 is formed between the base part 13 and the extension part 14.

In this way, in the transfer robot 1, the elbow articulated part 81a of the lower side arm unit 31a is configured so that it can be operated at the opposite side of the extension part 14 of the swivel base 12. Further, the stepped portion 15 is formed at the extension part 14 of the swivel base 12.

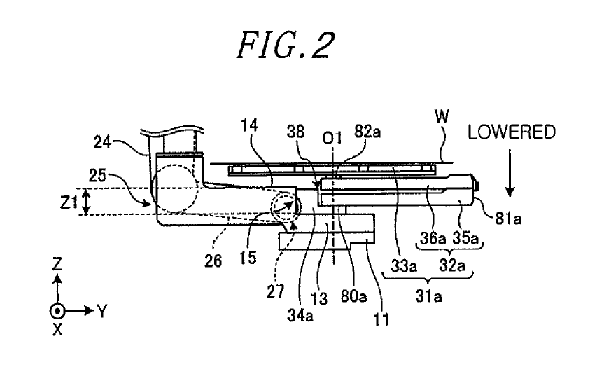

Accordingly, as shown in FIG. 2, the transfer robot 1 is configured so that a portion of the arm part 32a of the horizontal arm unit 30 is operated at a position lower than the upper surface of the extension part 14 to transfer the workpiece W. More specifically, when the horizontal arm unit 30 is lowered, at least the base end side arm 35a can be lowered to a position within the height range Z1 of the stepped portion 15 and the horizontal arm unit 30 can be lowered to the extent necessary to prevent at least the lower surface of the hand part 33a from contacting the upper surface of the extension part 14.

FIG. 2 illustrates a state such as the one mentioned above and represents a positional relationship between the swivel base 12 and the horizontal arm unit 30 when the horizontal arm unit 30 is in a lowermost position as seen in the X axis direction. That is, even if the horizontal arm unit 30 is in the lowermost position, at least the base end side arm 35a can swivel about the base end articulated part 80a within the height range Z1 defined by the stepped portion 15 and also on a position over the upper surface of the base part 13.

Accordingly, even if the horizontal arm unit 30 is in the lowermost position, the motion of the arm part 32a is not interfered with. Further, as shown in FIG. 3A, since a distance of the elbow articulated part 81a from the swivel axis O1 in Y axis direction is reduced, it is possible to stop the range of motion of the robot from becoming unnecessarily large.

In addition, as is apparent from FIG. 2, since the stepped portion 38 is formed at the lower side support member 34a and the base end side arm 35a is rotatably supported on the upper surface of the lower stage of the stepped portion 38, it is not necessary to further lower the third articulated part 27 and the lower side support member 34a. For this reason, it is possible to reduce the required length of the first elevation arm 24 and the second elevation arm 26.

Meanwhile, an upper side arm unit 31b of the horizontal arm unit 30 is not shown in FIG. 2. The arm part 32a is in a folded state. Herein, the folded state means that both the base end side arm 35a and the leading end side arm 36a are disposed along the Y axis direction and overlapped with each other as seen in the Z axis direction.

In this way, in this transfer robot 1, the folding direction of the arm part 32a is opposite to the direction of the extension part 14 with respect to the swivel center of the swivel base 12 and the stepped portion 15 is formed at the swivel base 12. Accordingly, it is possible to lower the horizontal arm unit 30 until the position of the base end side arm 35a falls within the height range Z1 of the stepped portion 15. On this account, since the lowermost position of the horizontal arm unit 30 can be lower, it is possible to securely ensure an elevation range of the horizontal arm unit 30.

Meanwhile, in the conventional transfer robot disclosed in Japanese Patent No. 4466785, a pair of opposite leg units support the horizontal arm unit. Accordingly, the part corresponding to the extension part 14 of the present embodiment extends in opposite directions (which correspond to the positive and negative opposite directions of the Y axis in FIG. 3A) of the leg unit. For this reason, in the conventional transfer robot, contrary to the transfer robot 1 of the present embodiment, the base end side arm 35a cannot be lowered to a position that is lower than the upper surface of the extension part 14, thus resulting in poor elevation range.

Further, as shown in FIG. 1, the upper side arm unit 31b includes a hand part 33 on which a thin plate workpiece (not shown) as an object to be transferred is mounted, an arm part 32b for supporting the hand part 33b on a leading end thereof, and an upper side support member 34b. Herein, the hand part 33b corresponds to a second hand part and the arm part 32b corresponds to a second arm part.

The arm part 32b includes a base end side arm 35b and a leading end side arm 36b. The upper side support member 34b has a base end which is connected to the base end of the lower side support member 34a and is swivelably supported about the articulated axis O4 of the third articulated part 27. The base end of the base end side arm 35b is rotatably supported on the upper side support member 34b.

The base end of the leading end side arm 36b is rotatably supported on the leading end of the base end side arm 35b. The hand part 33b is rotatably supported on the leading end of the leading end side arm 36b. Further, as the base end side arm 35b and the leading end side arm 36b rotate, the hand part 33b moves linearly in the X axis direction. In a case where the transfer robot 1 is in a swivel position as shown in FIG. 1, the moving direction of the hand part 33b and the extending direction of the arm part 32b are referred to as the X axis direction.

As is apparent from FIG. 3A that will be described in detail below, an elbow articulated part 81b connecting the base end side arm 35b and the leading end side arm 36b of the arm part 32b is disposed on a side of the extension part 14 opposite to the elbow articulated part 81a of the arm part 32a with respect to the swivel center of the swivel base 12 as seen in the X axis direction. That is, the folding direction of the arm part 32b is directed to the extension part 14 side. As described above, in order to further lower the lowermost position of the lower side arm unit 31a, the elbow articulated part 81a is provided at the positive side of Y axis direction relative to the swivel axis O1, as seen in the X axis direction. Meanwhile, in this embodiment, the elbow articulated part 81b of the arm part 32b is provided at the negative side of the Y axis in the direction relative to the swivel axis O1, as seen in the X axis direction. Therefore, the moment acting on the first articulated part 23 of the leg unit 22 can be largely reduced.

Meanwhile, although the horizontal arm unit 30 is constructed by the lower side arm unit 31a and the upper side arm unit 31b in this embodiment, for example, it is also possible to construct the horizontal arm unit 30 without the upper side arm unit 31b.

[Operation of Transfer Robot]

For example, the transfer robot 1 of the first embodiment is configured to take a workpiece W out of a stocker (not shown) and transfer the workpiece W to a transfer position (not shown). Although a transfer action performed by the hand part 33a will be explained in this embodiment, it should be noted that a transfer action can be similarly performed by the hand part 33b. Also, for example, the workpieces W are regularly stacked in the stocker from a position adjacent to a ceiling to a position adjacent to the floor of a facility in which the transfer robot 1 is installed.

First, the transfer robot 1 causes the elevation mechanism 20 to raise or lower the horizontal arm unit 30 to vertically position the hand part 33 slightly below the workpiece to be taken out of the stocker.

Next, the transfer robot 1 drives the arm part 32a to linearly move the hand part 33a in a horizontal direction, to introduce the hand part 33a into the stocker storing the workpiece W and then to cause the elevation mechanism 20 to raise the horizontal arm unit 30. Thus, the workpiece W is mounted on the hand part 33a.

Next, the transfer robot 1 causes the arm part 32a to be contracted to linearly retract the hand part 33a having the workpiece W from the stocker in a horizontal direction. And then, the transfer robot 1 causes the swivel mechanism 10 to swivel the elevation mechanism 20 and the horizontal arm unit 30 so as to direct the leading end of the hand part 33a toward the transfer position of the workpiece W.

Next, the transfer robot 1 causes the arm part 32a to be expanded to linearly move the hand part 33a in a horizontal direction and then to introduce the hand part 33a over the transfer position. The transfer robot 1 causes the elevation mechanism 20 to lower the horizontal arm unit 30. Thus, the position of the hand part 33a is lowered and the workpiece W is mounted on the transfer position.

[Detailed Configuration of Transfer Robot 1]

Hereinafter, a configuration of the transfer robot 1 of the first embodiment will be described in detail. FIG. 3A is a front view schematically illustrating the transfer robot 1 in which the horizontal arm unit 30 is disposed at an uppermost position thereof and FIG. 3B is a side view schematically illustrating the transfer robot 1 in which the horizontal arm unit 30 is disposed at an uppermost position thereof. Hereinafter, an example wherein the arm parts 32a and 32b linearly moves the hand parts 33a and 33b in the X axis direction while the swivel position of the transfer robot 1 is fixed will be described.

First, the swivel mechanism 10 will be explained. As shown in FIG. 3A, the swivel base 12 of the swivel mechanism 10 includes the base part 12 swivelably attached to the base 11 and a extension part 14 extending horizontally from one end of the base part 13.

In this swivel base 12, in order to form the upper surface of the base part 13 at a position lower than the upper surface of the extension part 14 by reducing the thickness of the base part 13, a swivel motor 16 is arranged within the extension part 14. The driving force of the swivel motor 16 is transmitted to a reducer 17 within the base part 13 via a belt (not shown). An output shaft of the reducer 17 is fixed to the base 11. Accordingly, as the reducer 17 is driven, the swivel base 12 swivels about the swivel axis O1.

Although the swivel motor 16 is arranged within the extension part 14 in this embodiment, it is also possible to arrange the swivel motor 16 in the base part 13 so that the upper surface of the base part 13 is arranged at a position lower than the upper surface of the extension part 14 by studying an arrangement or a shape of the swivel motor 16 within the base part 13. Further, the shapes of the base part 13 and the extension part 14 are not limited to the shapes shown in FIG. 1, and other shapes may be used as long as the upper surface of the base part 13 is arranged at a position lower than the upper surface of the extension part 14. In addition, the base part 13 may have a region over which the arm part 33a passes while being expanded and contracted. And, the extension part 14 includes a region over which at least a portion of the hand part 33a and the workpiece W passes and does not include a region over which the arm part 33a passes while being expanded and contracted.

As mentioned above, the elevation mechanism 20 includes the strut 21 vertically extended from a leading end of the extension part 14 and the leg unit 22 supported on the leading end of the strut 21. Further, the leg unit 22 includes the first elevation arm 24 and the second elevation arm 26.

As seen in the Y axis direction as shown in FIG. 3B, the leg unit 22 is located between the horizontal arm unit 30 and the strut 21 and connects the horizontal arm unit 30 and the strut 21. That is, the strut 21, the first elevation arm 24, the second elevation arm 26, and the horizontal arm unit 30 are sequentially connected in the negative direction of the X axis.

As shown in FIG. 3B, the strut 21 extends upwards and has a leading end from which a motor accommodating part 61 is formed to project in a direction opposite to a support side of the first elevation arm 24. A part of the motor 41 of the first articulated part 23 is accommodated in the motor accommodating part 61. Meanwhile, a reducer accommodating part 62 is formed to project from the support side of the first elevation arm 24. And, the reducer 42 of the first articulated part 23 is accommodated in the reducer accommodating part 62.

The output shaft of the motor 41 is coupled to the input shaft of the reducer 42 and the output shaft of the reducer 42 is fixed to the base end portion of the first elevation arm 24. By doing so, the base end portion of the first elevation arm 24 is rotatably supported on the strut 21 by the first articulated part 23 having a horizontal rotational axis. And, as the motor 41 of the first articulated part 23 is driven, the posture of the first elevation arm 24 relative to the strut 21 is changed.

As shown in FIG. 3B, the first elevation arm 24 supported on the strut 21 extends from a base end thereof while being inclined in the negative direction of the X axis and a motor accommodating part 63 is formed to project in a direction opposite to a support side of the second elevation arm 26. A part of the motor 43 of the second articulated part 25 is accommodated in the motor accommodating part 63. Meanwhile, a reducer accommodating part 64 is formed to project from the support side of the second elevation arm 26. And, the reducer 44 of the second articulated part 25 is accommodated in the reducer accommodating part 64.

The output shaft of the motor 43 is coupled to the input shaft of the reducer 44 and the output shaft of the reducer 44 is fixed to the base end portion of the second elevation arm 26. By doing so, the base end portion of the second elevation arm 26 is rotatably supported on the first elevation arm 24 by the second articulated part 25 having a horizontal rotational axis. And, as the motor 43 of the second articulated part 25 is driven, the posture of the second elevation arm 26 relative to the first elevation arm 24 is changed.

The second elevation arm 26 extends from a base end thereof in a predetermined direction and has a leading end in which a reducer 46 of the third articulated part 27 is accommodated. Meanwhile, a motor 45a of the third articulated part 27 is accommodated in the lower side support member 34a of the horizontal arm unit 30. The output shaft of the motor 45a is coupled to the input shaft of the reducer 46 and the output shaft of the reducer 46 is fixed to the horizontal arm unit 30. In this way, the horizontal arm unit 30 is rotatably supported on the second elevation arm 24 by the third articulated part 27 having a horizontal rotational axis. And, as the motor 45a of the third articulated part 27 is driven, the posture of the horizontal arm unit 30 relative to the second elevation arm 26 is changed.

The transfer robot 1 causes the motors 41, 43, and 45a provided on each of the articulated parts 23, 25, and 27 to be suitably rotated, and thus the horizontal arm unit 30 can be lifted while it is maintained in a horizontal posture. Further, in this embodiment, as seen in the X axis direction as shown in FIG. 3A, the operation of elevating the horizontal arm unit 30 is performed such that the base end of the arm parts 32a and 32b of the horizontal arm unit 30 moves vertically along the swivel axis O1.

Further, when a mounting surface of the hand part 33a and 33b on which the workpiece W is mounted and a mounting surface of the stocker on which the workpiece W is mounted are inclined to each other in a rolling direction, the hand parts 33a and 33b can be inclined from the horizontal by driving the motor 45a of the third articulated part 27. Herein, the rolling direction means a rotational direction about an axis of a moving direction of the hand parts 33a and 33b.

In addition, when an axis of the hand parts 33a and 33b in an expansion and contraction direction and an axis of the workpiece W introducing direction into the stocker or a target transfer position are inclined to each other in a yawing direction, the inclination may be removed by driving the swivel motor 16. Herein, the yawing direction means a rotational direction about the vertical moving direction of the elevation mechanism 20.

In addition, when a mounting position of the workpiece W in the stocker is laterally offset relative to the expansion and contraction direction of the hand parts 33a and 33b in a left and right direction, the position of the hand parts in the left and right direction relative to an axis of the expansion and contraction direction may be corrected by driving the motors 41, 43 and 45a provided on the articulated parts 23, 25 and 27 while the hand parts 33a and 33b are maintained in a horizontal state.

Now, a wiring arrangement of cables 71 to 73 for supplying a driving current to the motors 41, 43 and 45a provided on each of the articulated parts 23, 25, 27 or sending a signal from an encoder of each motor 41, 43 and 45a will be described in detail, by referring to FIG. 3A to FIG. 3C. FIG. 3C is a side sectional view schematically illustrating a portion of the interior configuration of the transfer robot 1.

In the transfer robot 1, as shown in FIG. 3B, an opening 39a is formed on a positive side of the X axis in an intermediate portion of the strut 21 for wiring the cables 71 to 73. Further, an opening 39b is formed on the negative side of the X axis in a central portion of the first elevation arm 24 and an opening 39c is formed on the positive side of the X axis in the central portion thereof.

As shown in FIG. 3C, the cables 71 to 73 are inserted into the strut 21 via the swivel base 12. One cable 71 out of the cables 71 to 73 inserted into the strut 21 is connected to the motor 41.

Meanwhile, the remaining cables 72 and 73 are withdrawn from the opening 39a of the strut 21 and inserted into a tubular protective member 51, as shown in FIG. 3C. The tubular protective member 51 is arranged along a leading end periphery of the strut 21 and a base end periphery of the first elevation arm 24, as shown in FIG. 3B. Further, the tubular protective member 51 is arranged along the negative side of the Y axis in the base end of the first elevation arm 24 in order not to hinder rotation of the first elevation arm 24.

A termination of the tubular protective member 51 is located in the opening 39b of the first elevation arm 24 and the cables 72 and 73 inserted into the tubular protective member 51 are inserted into the first elevation arm 24 via the opening 39b, as shown in FIG. 3C.

The cable 72 out of the cables 72 and 73 inserted into the first elevation arm 24 is connected to the motor 43. Herein, the cables 73 are withdrawn from the opening 39c of the first elevation arm 24 and inserted into a tubular protective member 52. The tubular protective member 52 is arranged along the second elevation arm 26 and fixed to the lower side support member 34a. Also, a support member 50 which extends to the positive side of the X axis is fixed to the second elevation arm 26. Further, the intermediate portion of the tubular protective member 52 is supported by the support member 50.

The cable 73 inserted into the tubular protective member 52 is inserted into the lower side support member 34a of the horizontal arm unit 30. The cable 73, which is wired within the lower side support member 34a, includes a cable connected to the motor 45a and a cable connected to the hand parts 33a and 33b of the horizontal arm unit 30.

The cable 73 inserted into the lower side support member 34a branches within the lower side support member 34a so that a portion of the cable is connected to the motor 45a. The remaining portion of the cable 73 is connected to the hand part 33a via the base end side arm 35a and the leading end side arm 36a. Further, another portion thereof is connected to the hand part 33b via the upper side support member 34b, the base end side arm 35b and the leading end side arm 36b. For example, the cable connected to the hand parts 33a and 33b includes an air piping for adsorbing the workpiece W or a sensor line connected to a sensor for detecting the adsorption.

As mentioned above, the first elevation arm 24 extends upwards while being inclined in the negative direction of the X axis. Accordingly, as shown in FIG. 3A, it is possible to prevent the tubular protective members 51 and 52 equipped with the cable from interfering with the second articulated part 25. That is, even if the first elevation arm 24 rotates relative to the second elevation arm 26, a space 90 illustrated in FIG. 3B makes it possible to prevent the tubular protective member 51 from interfering with the first elevation arm 24 and the second elevation arm 26.

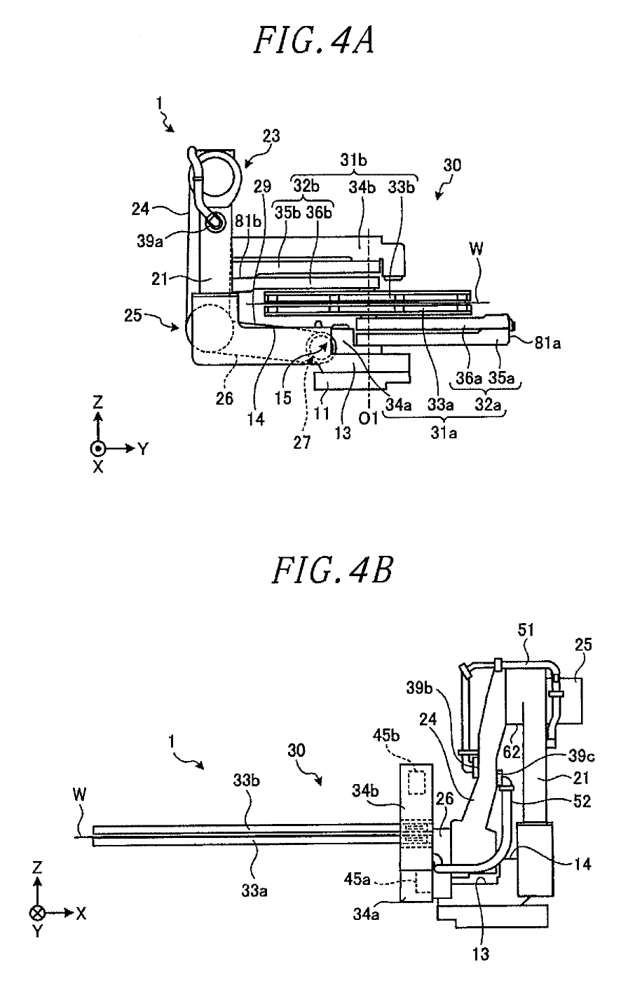

Similarly, even if the first elevation arm 24 or the second elevation arm 26 rotates relative to the strut 21, a space 91 illustrated in FIG. 3B makes it possible to prevent the tubular protective member 52 from interfering with the strut 21 or the second elevation arm 26. That is, the cable can be suitably handled between the strut 21 and the second elevation arm 26. This effect can be easily appreciated from FIG. 4B which will be described below.

Generally, the tubular protective member 51 or 52 can be easily handled by inserting the cables through hollow holes which are respectively formed in the strut 21, the first elevation arm 24, the second elevation arm 26 and each of the articulated parts 23, 25 and 27. However, by handling the cables as in this embodiment, the configuration of each articulated part 23, 25 and 27 can be simplified and thus the cable can be easily checked and replaced.

Further, although the cables 72 and 73 outside the transfer robot 1 are protected by the tubular protective members 51 and 52 in this embodiment, the present invention is not limited to this configuration. For example, when the cables 72 and 73 are made of a durable material, the cables 72 and 73 can be withdrawn out of the transfer robot 1 without using the tubular protective members 51 and 52.

Next, the horizontal arm unit 30 will be explained in detail. As shown in FIG. 3A, the horizontal arm unit 30 includes a lower side arm unit 31a and an upper side arm unit 31b. Each of the arm units 31a and 31b includes the arm parts 32a and 32b, the hand parts 33a and 33b, the lower side support member 34a and the upper side support member 34b, respectively. Further, the upper side support member 34b corresponds to a second arm support portion.

The arm parts 32a and 32b includes the base end side arms 35a and 35b and the leading end side arms 36a and 36b, respectively. Base end portions of the base end side arms 35a and 35b are respectively connected to the leading end portions of the lower side support member 34a and the upper side support member 34b by the base end articulated parts 80a and 80b so as to rotate about an axis parallel to the swivel axis O1.

Base end portions of the leading end side arms 36a and 36b are respectively connected to the leading end portions of the base end side arms 35a and 35b by the elbow articulated parts 81a and 81b so as to rotate about an axis parallel to the swivel axis O1. In addition, base end portions of the hand parts 33a and 33b are respectively connected to the leading end portions of the leading end side arms 36a and 36b by the leading end articulated parts 82a and 82b so as to rotate about an axis parallel to the swivel axis O1.

In the transfer robot 1 of this embodiment, as seen in the X axis direction as shown in FIG. 3A, a rotational axis of the base end articulated parts 80a and 80b and a rotational axis of the leading end articulated parts 82a and 82b coincide with the swivel axis O1. However, the positional relationship between these axes is not limited to this relationship. That is, these axes may be offset from each other without departing from the scope of the present invention.

The lower side support member 34a houses the motor 45a. As the motor 45a is driven, the leading end articulated part 80a, the elbow articulated part 81a, and the leading end articulated part 82a rotate. Similarly, the upper side support member 34b houses the motor 45b. As the motor 45 is driven, the leading end articulated part 80b, the elbow articulated part 81b, and the leading end articulated part 82b rotate.

Specifically, the motor 45a is provided between the third articulated part 27 and the base end articulated part 80a within the lower side support member 34a. The driving force of the motor 45a is transmitted to the leading end articulated part 80a, the elbow articulated part 81a, and the leading end articulated part 82a via a timing belt.

On this account, the base end side arm 35a rotates relative to the lower side support member 34a, the leading end side arm 36a rotates relative to the base end side arm 35a and the leading end of the leading end side arm 36a linearly moves in the X axis direction. Thus, the hand part 33a attached to the leading end portion of the leading end side arm 36a moves in the X axis direction. Further, the orientation of the hand part 33a is constantly maintained by rotating the hand part 33a relative to the leading end side arm 36a.

Meanwhile, the motor 45b is provided at the leading end portion of the upper side support member 34b. The driving force of the motor 45b is transmitted to the leading end articulated part 80b, the elbow articulated part 81b, and the leading end articulated part 82b via a timing belt. On this account, the base end side arm 35b rotates relative to the upper side support member 34b, the leading end side arm 36b rotates relative to the base end side arm 35b and the leading end of the leading end side arm 36b linearly moves in the X axis direction. Therefore, the hand part 33b attached to the leading end portion of the leading end side arm 36b moves in the X axis direction. Further, the orientation of the hand part 33b is constantly maintained by rotating the hand part 33b relative to the leading end side arm 36b.

By using the timing belt in this way, reduction in weight of the horizontal arm unit 30 can be achieved and thus the moment acting on the elevation mechanism 20 can be reduced. Instead of driving the plurality of articulated parts using the timing belt, each motor may be provided to each of the articulated parts. Specifically, each motor may be provided on the base end articulated parts 80a and 80b, the elbow articulated parts 81a and 81b, and the leading end articulated parts 82a and 82b, so that each motor drives the corresponding articulated part.

Further, in the horizontal arm unit 30, the base end of the lower side support member 34a is connected to the base end of the upper side support member 34b so that the leading end of the lower side support member 34a and the leading end of the upper side support member 34b are directed in the same direction and vertically opposed to each other with a space therebetween. Thus, the upper side arm unit 31b is supported by the lower side arm unit 31a.

The upper side support member 34 extends upward while being inclined in the negative direction of Y axis from the base end thereof and then extends in the positive direction of the Y axis to roughly form a J shape, as seen from a side view. Thus, a length of the upper side support member 34b in the Y axis direction can be reduced while ensuring an accommodation space of the hand part 33b in a folded state. Further, the center of the horizontal arm unit 30 can be located close to the swivel axis O1.

In addition, when the arm parts 32a and 32b are in a folded state, the elbow articulated part 81a of the arm part 32a is arranged on the opposite side of the elbow articulated part 81b of the arm part 32b, as seen in the X axis direction which is the direction in which the arm parts 32a and 32b expand and contract. That is, a folding direction of the arm part 32a is opposite to a folding direction of the arm part 32b, and the folding direction of the arm part 32b is directed to the strut 21. On this account, the moment of the leg unit 22 acting on the first articulated part 23 can be reduced.

Next, the transfer robot 1 of the first embodiment in a state where the horizontal arm unit 30 is disposed in a lowermost position will be explained. FIG. 4A is a front view schematically illustrating the transfer robot 1 which has the horizontal arm unit 30 disposed at a lowermost position thereof and FIG. 4B is a side view schematically illustrating the transfer robot 1 in which the horizontal arm unit 30 is disposed at the lowermost position thereof.

As mentioned above, FIG. 3A and FIG. 3B represent the transfer robot in a state wherein the horizontal arm unit 30 is raised to the uppermost position by the elevation mechanism 20. From this state, the horizontal arm unit 30 is lowered to the lowermost position by the elevation mechanism 20. At this time, the state of the transfer robot 1 is shown in FIG. 4A and FIG. 4B.

When the horizontal arm unit 30 is in the lowermost position as shown in FIG. 4A, the base end side arm 35a of the arm part 32a is lowered to a position which falls within the height range Z1 of the stepped portion 15 and also in which the hand part 33a is arranged over the upper surface of the extension part 14.

In the transfer robot 1 of the first embodiment, the upper surface of the base part 13 is formed at a position lower than the upper surface of the extension part 14 and therefore the base end side arm 35a of the arm part 32a can be further lowered. Meanwhile, since the hand part 33a is allowed to be located at a position higher than the upper surface of the extension part 14, the extension part 14 does not hinder the movement of the hand part 33a. That is, a lower surface of the base end side arm 35a of the arm part 32a rotates within the height range between the upper surface of the base part 13 and the upper surface of the extension part 14 and over the upper surface of the base part 13. Also, naturally, the arm part 32a rotates until the base end side arm 35a is parallel to the X axis. That is, the arm part 32a rotates about the base end articulated part 80a only within a range of ±90° from the folded state.

Accordingly, the lowermost position of the horizontal arm unit 30 can be further lowered and thus a wide elevation range of the horizontal arm unit 30 can be ensured.

Further, when the horizontal arm unit 30 is located at the lowermost position, the leading end of the first elevation arm 24 is positioned to substantially overlap with the strut 21, as seen in the X axis direction. Thus, it is possible to limit the operational range of the transfer robot 1 in the Y axis direction. Accordingly, it is possible to prevent the operational range of the transfer robot 1 from becoming wide.

In addition, when the horizontal arm unit 30 is located at the lowermost position as shown in FIG. 4A, as seen in the X axis direction, the lower side support member 34a of the horizontal arm unit 30 is positioned to substantially overlap with the extension part 14 of the swivel base and a portion of the upper side support member 34b of the horizontal arm unit 30 is positioned to substantially overlap with the strut 21. Thus, it is possible to limit the operational range of the transfer robot 1 in the Y axis direction. Accordingly, it is possible to prevent the operational range of the transfer robot 1 from becoming wide.

Further, when the horizontal arm unit 30 is located at the lowermost position as shown in FIG. 4A, the second elevation arm 26 has a posture downwardly inclining from the base end toward the leading end thereof. In this way, an angle formed by the first elevation arm 24 and the second elevation arm 26 forms an obtuse angle. As a result, when the horizontal arm unit 30 is located at the lowermost position, it is possible to shorten the length of the first elevation arm 24 and/or the second elevation arm 26, as compared to a case where the angle formed by the first elevation arm 24 and the second elevation arm 26 is less than a right angle. As a result, it is possible to securely ensure an elevation range of the elevation mechanism 20 while reducing the moment acting on the leg unit 22 which supports the horizontal arm unit 30.

Further, in order to prevent the horizontal arm unit 30 from being positioned on the base part 13 of the swivel base 12, the length of the base part 13 in the negative direction of X axis is restricted. Accordingly, as shown in FIG. 4B, the lower side support member 34a of the horizontal arm unit 30 can be further lowered to a position lower than the upper surface of the base part 13 and thus it is possible to securely ensure the elevation range of the horizontal arm unit 30.

In addition, as shown in FIG. 3A and FIG. 4A, in the horizontal arm unit 30, the lower side support member 34a is connected to the upper side support member 34b on a side of the strut 21 relative to the swivel axis O1. As a result, the center of the horizontal arm unit 30 can be located closer to the third articulated part 27, as compared to the case where the lower side support member 34a is connected to the upper side support member 34b on the opposite side of the strut 21 relative to the swivel axis O1. As a result, it is possible to securely ensure an elevation range of the elevation mechanism 20 while reducing the moment acting on the leg unit 22.

Further, when the horizontal arm unit 30 is located at the lowermost position, the second elevation arm 26 can be inclined so that at least a portion of the hand part 33a is positioned within the height range of the upper surface 29 of an inclined part in the second elevation arm 26. Thus, the leading end of the second elevation arm 26 can be further inclined downwards and it is possible to further shorten the length of the first elevation arm 24 and/or the second elevation arm 26.

Further, in the transfer robot 1, when the horizontal arm unit 30 is located at the lowermost position, the cable 73 protected by the tubular member 52 is positioned between the strut 21 and the first elevation arm 24 and between the strut 21 and the second elevation arm 26 (see, FIG. 4B).

Specifically, in the transfer robot 1, the strut 21 is provided with the reducer accommodation part 62 projecting in the negative direction of the X axis and the first elevation arm 24 extends while being inclined in the negative direction of the X axis. As shown in FIG. 3B, the reducer accommodation part 62 and the first elevation arm 24 define spaces 90, 91 between the strut 21 and the horizontal arm unit 30. The cables 72, 73 which are withdrawn from the opening 39a of the strut 21 and protected by the tubular member 51 and the cable 73 which are withdrawn from the opening 39c of the first elevation arm 24 and protected by the tubular member 52 is arranged in these spaces 90, 91. Thus, the spaces between the strut 21 and the first elevation arm 24 and between the strut 21 and the second elevation arm 26 can be effectively utilized to wire the cables 72, 73.

In addition, since the first elevation arm 24 extends while being inclined in the negative direction of the X axis, the cables 72, 73 protected by the tubular members 51 are positioned at the positive side of X axis relative to the leading end of the first elevation arm 24. Thus, it is possible to prevent the cables 72, 73 from contacting with the horizontal arm unit 30 during elevation.

Further, in the transfer robot 1, the extension part 14 is formed in an approximate L shape as seen from a plan view, and the leading end of the extension part 14 is offset in the positive direction of the X axis relative to the swivel axis O1. Herein, the strut 21, the first elevation arm 24, the second elevation arm 26, and the horizontal arm unit 30 are sequentially arranged in the negative direction of the X axis. Therefore, the center of the transfer robot 1 can be located close to the swivel axis O1.

As mentioned above, since the horizontal arm unit 30 is supported by one leg unit 22 in the above transfer robot 1, the configuration thereof can be simplified. Furthermore, in the transfer robot 1, the elbow articulated part 81a of the arm part 32a is operated at the opposite of the extension part 14 relative to the swivel center of the swivel base 12. Also, the upper surface of the base part 13 is formed at a position lower than the upper surface of the extension part 14 so that the stepped portion 15 is formed on the swivel base 12. On this account, the hand part 33a is located at a position higher than the upper surface of the extension part 14 and can lower the horizontal arm unit 30 until the base end side arm 35a of the arm part 32a falls within the height range of the stepped portion 15. Accordingly, it is possible to lower the horizontal arm unit 30 to a lower position.

### Second Embodiment

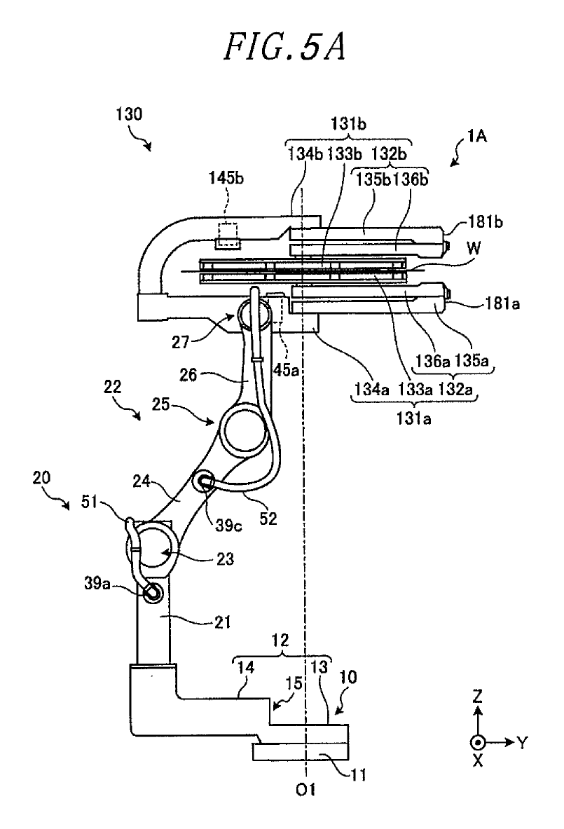

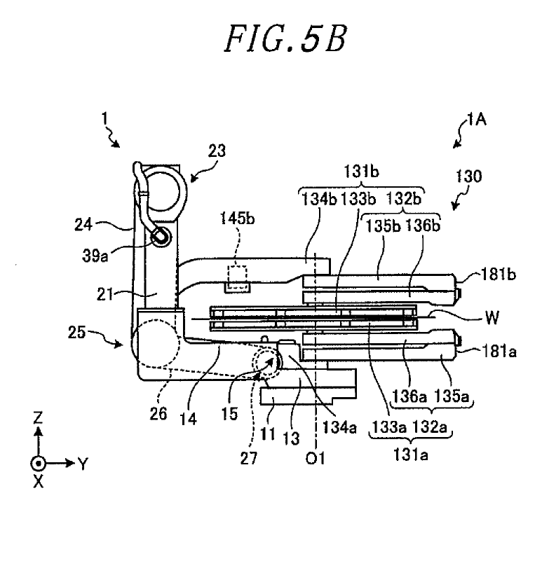

Next, the transfer robot of the second embodiment will be explained by referring to the accompanying drawings. The transfer robot of the second embodiment is different from the transfer robot of the first embodiment in terms of the configuration of the horizontal arm unit. FIG. 5A is a schematic view illustrating the transfer robot 1A of the second embodiment in which the horizontal arm unit is disposed at an uppermost position thereof, and FIG. 5B is a schematic view illustrating the transfer robot 1A of the second embodiment in which the horizontal arm unit is disposed at a lowermost position thereof. Further, the same or similar element will be denoted by the same reference numeral as that of the first embodiment, and the duplicated explanation thereof will be omitted. FIGS. 5A and 5B represent the transfer robot in which arm parts 132a and 132b are in a folded state.

As shown in FIGS. 5A and 5B, the transfer robot 1A includes a horizontal arm unit 130 which has a lower side arm unit 131a and an upper side arm unit 131b. Each of the arm units 131a and 131b includes arm parts 132a and 132b, hand parts 133a and 133b, a lower side support member 134a, and an upper side support member 134b.

The configuration of the lower side arm unit 131a is similar to that of the lower side arm unit 31a. However, the configuration of the upper side arm unit 131b is largely different from the upper side arm unit 31b in that the elbow articulated part 181b of the hand part 133b is disposed opposite to the elbow articulated part 81b of the hand part 33b.

Specifically, as seen in the X axis direction, the hand part 133b is connected to the upper side arm unit 131b so that the elbow articulated part 181b of the hand part 133b, as like the elbow articulated part 181a of the hand part 133a, is located on the opposite side of the extension part 14 relative to the swivel center of the swivel base 12. That is, folding direction of the hand part 133b is the same as that of the hand part 133a.

With this configuration, it is not necessary to house the arm part 132b to be extendable in a space between the lower side support member 134a and the upper side support member 134b. Accordingly, the space between the lower side support member 134a and the upper side support member 134b can be reduced, as compared to the transfer robot 1 of the first embodiment. As a result, in the transfer robot 1A of the second embodiment, the overall height (in the Z axis direction) thereof can be lowered without changing the range of the elevation operation, as compared to the transfer robot 1 of the first embodiment.

Further, the motor 145b for expanding and contracting the arm part 132b is not disposed in the leading end portion of the upper side support member 134b but disposed in the center portion of the upper side support member 134b. Therefore, it is possible to prevent the motor from being interfered with by the arm part 132b during the expansion and contraction thereof, and the moment acting on the first articulated part 23 and the strut 21 can be reduced.

### Third Embodiment

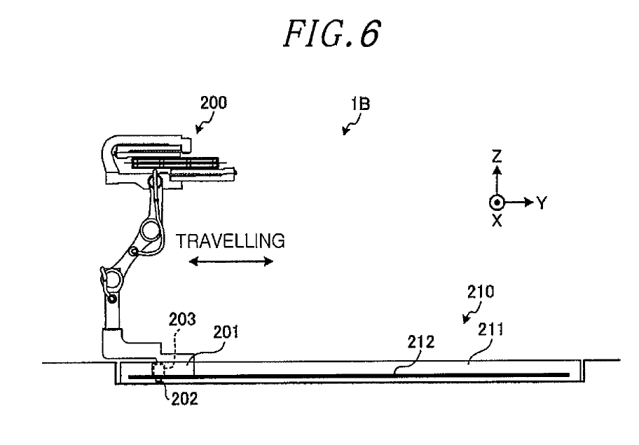

Next, the transfer robot of the third embodiment will be explained by referring to the accompanying drawings. The transfer robot of the third embodiment is different from the transfer robots 1, 1A of the first and second embodiments in that a travelling mechanism 210 is further provided. FIG. 6 is a view illustrating a configuration of the transfer robot 1B in accordance with the third embodiment.

The transfer robot 1B in accordance with the third embodiment includes a robot main body 200 and a travelling mechanism 210. The configuration of the robot main body 200 is the same as that of the transfer robot 1 except for the configuration of the base. The travelling mechanism 210 is provided with a concave groove 211 which is arranged in the direction of the Y axis. A rack gear 212 is arranged in the concave groove 211 in the direction of the Y axis.

Meanwhile, a travelling motor 202 and a pinion gear 203 are provided in the base 201 of the robot main body 200. The pinion gear 203 is meshed with the rack gear 212 of the travelling mechanism 210 so that the pinion gear 203 is rotated by the travelling motor 202. Accordingly, as the travelling motor 202 is driven, the pinion gear 203 rotates and the robot main body 200 moves along the Y axis direction (arrangement direction of the rack gear 212), the Y axis being the travelling axis. Further, a linear guide (not shown) is further provided and the robot main body 200 is driven by the rack and pinion and travels while being guided by the linear guide.

Herein, although an example of using the rack and pinion as the travelling mechanism 210 of the robot main body 200 is used in the foregoing description, the travelling mechanism 210 of the robot main body 200 is not limited to this configuration. For example, instead of the rack and pinion, a pulley and belt may be used as the travelling mechanism.

Although the robot main body 200 which has the horizontal arm unit 30 of the transfer robot 1 in accordance with the first embodiment is illustratively explained in the third embodiment, the present embodiments are not limited to this. For example, the robot main body 200 which has the horizontal arm unit 130 of the robot main body 1A of the second embodiment may be used.

Other effects or modifications can be derived by those skilled in the art. While the invention has been shown and described with respect to the preferred embodiments, it will be understood by those skilled in the art that various changes and modifications may be made without departing from the spirit and scope of the invention as defined in the following claims.

For example, although the transfer robot including two hand parts and two arm parts in the foregoing description, the number of the hand part and the arm part is not limited to two. For example, the transfer robot may include the arm part 32a, the hand part 33a and the upper side support member 34a without the arm part 32b, the hand part 33b, and the upper side support member 34b. Further, although a thin plate workpiece such as a glass substrate for a liquid crystal display or a semiconductor wafer is illustratively explained as an object to be transferred, the object to be transferred is not limited to this.

What is claimed is:

1. A transfer robot comprising:
a swivel base including a base part attached to a base so as to swivel about a vertical axis thereof and a extension part extending from the base part in one horizontal direction;
a strut vertically extended from a leading end portion of the extension part;
a first elevation arm supported on a leading end portion of the strut via a first articulated part and configured to rotate about a first horizontal axis;
a second elevation arm supported on a leading end of the first elevation arm via a second articulated part and configured to rotate about a second horizontal axis which is parallel to the first horizontal axis; and
a horizontal arm unit including an arm part for moving a hand part in a direction parallel to the first and second horizontal axis, on which an object to be transferred is mounted, the horizontal arm unit being supported on a leading end portion of the second elevation arm via a third articulated part and being configured to rotate about a third horizontal axis which is parallel to the second horizontal axis,
wherein a portion of the arm part in the horizontal arm unit can be operated at a position lower than an upper surface of the extension part.

2. The transfer robot of claim 1, wherein the arm part is configured to move the hand part in a direction parallel to the first and second horizontal axis at a side of the vertical axis relative to the strut.

3. The transfer robot of claim 1, wherein the arm part of the horizontal arm unit is arranged so that an elbow articulated part connecting a plurality of arms of the arm part to each other operates on the opposite side of the extension part with respect to a center axis around which the swivel base swivels,
an upper surface of the base part in the swivel base is formed at a position lower than the upper surface of the extension part to form a stepped portion, and
the horizontal arm unit is capable of descending until the hand part is located at a position over the upper surface of the extension part and a base end side arm of the arm part falls within a height range of the stepped portion.

4. The transfer robot of claim 3, wherein when the base end side arm of the arm part falls within the height range of the stepped portion, a leading end of the first elevation arm is located to overlap with the strut as viewed in a moving direction of the arm part.

5. The transfer robot of claim 3, wherein when the base end side arm of the arm part falls within the height range of the stepped portion, the second elevation arm has a posture downwardly inclined from a base end thereof toward a leading end thereof.

6. The transfer robot of claim 1, wherein the horizontal arm unit includes
a lower side arm unit which has the arm part, the hand part and an arm support part supporting the arm part on a leading end portion thereof; and
an upper side arm unit which has a second hand part on which the object to be transferred is mounted, a second arm part configured to move the second hand part in a direction parallel to the first and second horizontal axis by a plurality of arms and a second arm support part supporting the second arm part on a leading end portion thereof, a base end of the second arm support being supported on a base end portion of the arm support part, and
wherein the second arm part is arranged so that the elbow articulated part connecting the arms of the arm part to each other and an elbow articulated part connecting the arms of the second arm part to each other are located in a direction opposite to each other with respect to the swivel center of the swivel base.

7. The transfer robot of claim 1, wherein the horizontal arm unit includes
a lower side arm unit which has the arm part, the hand part and an arm support part supporting the arm part on a leading end portion thereof; and
an upper side arm unit which has a second hand part on which the object to be transferred is mounted, a second arm part configured to move the second hand part in a direction parallel to the first and second horizontal axis by a plurality of arms and a second arm support part supporting the second arm part on a leading end portion thereof, a base end of the second arm support being supported on a base end of the arm support part, and
wherein the second arm part is arranged so that the elbow articulated part connecting the arms of the arm part to each other and a second elbow articulated part connecting the arms of the second arm part to each other are located in the same direction to each other with respect to the swivel center of the swivel base.

8. The transfer robot of claim 1, further comprising a cable connected to the horizontal arm unit,
wherein when the base end side arm of the arm part falls within the height range of the stepped portion, a portion of the cable is located between the strut and the first elevation arm and between the strut and the second elevation arm.

9. The transfer robot of claim 1, further comprising a travelling mechanism for moving the base in a horizontal direction.
